(19) United States
(12) Patent Application Publication
(10) Pub. No.: US 2005/0271420 A1
(43) Pub. Date: Dec. 8, 2005

(54) Charging apparatus, and image forming apparatus equipped with same

(76) Inventors: Yuji Arai, Kanagawa (JP); Tokuya Ojimi, Kanagawa (JP); Takaaki Tawada, Kanagawa (JP); Toshio Koike, Kanagawa (JP); Ken Amemiya, Tokyo (JP); Takeshi Shintani, Kanagawa (JP); Masanori Kawasumi, Kanagawa (JP); Takuzi Yoneda, Tokyo (JP); Masami Tomita, Shizuoka (JP); Takeshi Uchitani, Kanagawa (JP); Nobuo Kuwabara, Kanagawa (JP); Hiroyuki Nagashima, Kanagawa (JP); Hiroshi Ono, Tokyo (JP); Takatsugu Fujishiro, Tokyo (JP); Haruji Mizuishi, Tokyo (JP); Masaharu Yokono, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/143,982

(22) Filed: Jun. 3, 2005

(30) Foreign Application Priority Data
Jun. 8, 2004 (JP) 2004-169347 (JP)
Aug. 26, 2004 (JP) 2004-246105 (JP)

(51) Int. Cl. G03G 15/02

(52) U.S. Cl. 399/176

(57) ABSTRACT

A charging apparatus, process cartridge, and image forming apparatus with which current fluctuation values in the charging current can be suppressed, and image defects caused by filming and the like can be prevented, by specifying a permissible gap fluctuation value by quantitatively ascertaining the relationship between the fluctuation value in charging current and the fluctuation value in the gap between the photosensitive body and the charging roller. In a charging apparatus equipped with a charging roller provided at a minute gap away from a photosensitive body, for performing charging, the relationship Gmax−Gmin≦30 (μm) is satisfied when the gap (μm) between the charged side of the photosensitive body and the charging side of the charging roller has a maximum value Gmax (μm) and a minimum value Gmin (μm).

### BACKGROUND OF THE INVENTION

1. Field of the Invention

The present invention relates to an image forming apparatus that makes use of an electrophotographic process, such as a copier, printer, or fax machine, and more particularly relates to an image forming apparatus equipped with a non-contact type of charging apparatus that performs charging by superimposing an AC bias voltage over a DC bias voltage as the charging bias voltage.

2. Description of the Related Art

With an electrophotographic image forming apparatus, a charging treatment is performed by imparting a charge of a specific polarity, produced by discharge, to the surface of a photosensitive body (image carrier), the surface of the photosensitive body is exposed to light to form an electrostatic latent image, and toner that has been charged to the same polarity as this electrostatic latent image is supplied from a developing apparatus, thereby forming a toner image. The toner image formed on the photosensitive body is transferred to recording paper or the like that has been supplied from a paper feed apparatus, and then subjected to heat and pressure to fix the image on the recording paper. Since some toner remains behind on the surface of the photosensitive after the toner image has been transferred, it is cleaned away by a cleaning blade, cleaning brush, or other cleaning member before moving on to the subsequent charging step.

In recent years, because it produces less ozone and consumes less power, the most common way to charge the surface of a photosensitive body has been to employ a contact type of charging apparatus which charges the surface of the photosensitive body by bringing a charging roller (comprising an electroconductive material forming into a roller shape) into contact with the surface of the photosensitive body, and applying voltage between the photosensitive body and the charging roller in this state.

Nevertheless, because the charging roller used in such charging apparatus involving contact charging is produced by providing an elastic roller component molded from an electroconductive rubber over the outside of a metal core, for example, when this elastic roller component is left pressed against the surface of the photosensitive body for an extended period, the substances contained in the elastic roller component, such as a plasticizer, can ooze out onto the surface, where they can foul the surface of the photosensitive body.

Also, with this contact charging apparatus, since the charging is performed with the charging roller or other charging member in contact with the surface of the photosensitive body, any untransferred toner or the like remaining on the surface of the photosensitive body after image transfer ends up moving to and fouling the surface of the charging member, and this is sometimes a cause of diminished charging performance.

In view of this, non-contact charging apparatus have been proposed in an effort to solve this problem. For instance, in Japanese Laid-Open Patent Application H3-240076, gap control members consisting of a spacer, tape, or the like of a specific thickness are attached at both ends of the elastic roller component of a charging roller, so that the charging roller does not come into contact with the surface of the photosensitive body except for the portions at the ends where the gap control members are disposed, and the photosensitive body is charged in this state.

With a charging apparatus involving non-contact charging such as this, since the effective image formation region, that is, the region to the inside of the gap control members at the ends of the charging roller, does not touch the photosensitive body, this solves the problems encountered with the above-mentioned contact charging apparatus, namely, the adhesion to the photosensitive body of substances contained in the elastic roller component of the charging roller, and the movement of toner and other such material adhering to the surface of the photosensitive body to the surface of the charging roller.

Unfortunately, with a non-contact charging apparatus in which the photosensitive body and the charging roller are brought close together but without touching, the gap between the photosensitive body and the charging roller can change over time, resulting in a change in the charging current, which leads to image inconsistency and other such problems. Accordingly, Japanese Laid-Open Patent Application 2002-132019, for example, proposes a charging roller made from a non-elastic material such as a thermoplastic resin, rather than from an elastic material such as a rubber or elastomer. A problem with this proposal, however, was that the fluctuation in charging current brought about by a change in the gap between the photosensitive body and the charging roller over time was not taken into account, so the amount of current and other such conditions related to the occurrence of filming and so forth could not be factored in, and the permissible range for gap fluctuations had to be determined empirically.

Meanwhile, with the above-mentioned electrophotographic image forming apparatus, the parts characteristic of an electrophotographic process, consisting of an photosensitive body, a charging apparatus, a developing apparatus, and so on, are prone to mechanical wear and toner fouling. Japanese Laid-Open Patent Application H-8335022, for example, discusses a process cartridge that is removably integrated into an apparatus main body and in which these parts are either consumables or periodically replaced parts, and the improper installation of this process cartridge is prevented and the stable supply of high voltage is ensured by focussing on the reliability of an attachment structure in which various kinds of high-voltage electrode on the apparatus main body side, such as high-voltage charging electrodes, high-voltage developing electrodes, high-voltage or ground electrodes for the photosensitive body, are in contact with respectively corresponding high-voltage electrodes on the process cartridge side. Specifically, the above application proposes an image forming apparatus with which the installation of a removable process cartridge in an apparatus main body can be easily detected electrically by using, for example, a photosensitive body comprising an installation detection means for detecting the installation of a process cartridge by means of a comparator that compares a reference voltage with the output voltage of an error amplifier provided to a feedback circuit for subjecting the charging roller to a specific action.

Japanese Laid-Open Patent Application H10-312100 discusses an image forming apparatus that does not make use of a cleaning apparatus, and proposes that any remaining toner in the developing apparatus can be removed more efficiently by improving the partability between the toner and the photosensitive body by coating the photosensitive body with a lubricant that is held in the bristles of a brush and is wiped away as the charging brush roller of the charging apparatus charges the surface of the photosensitive body.

Japanese Laid-Open Patent Application 2003-195684 discusses an image forming apparatus that does not make use of a cleaning apparatus, and proposes that remaining toner in the developing apparatus can be removed more efficiently by improving the partability between the toner and the photosensitive body by coating the photosensitive body with a lubricant dispensed from the transfer apparatus.

Another method that has been employed in the past in order to charge the surface of a photosensitive body more uniformly is to apply a charge bias in which an alternating current (AC) voltage is superimposed over a direct current (DC) voltage. With an image forming apparatus in which this method is employed, a larger amount of AC is required than with a DC-only charging system in order to obtain the desired charging potential. For example, Japanese Laid-Open Patent Application 2001-109238 proposes that the peak-to-peak voltage (Vpp) be at least twice the discharge commencement voltage. However, when more AC current than necessary is used, the photosensitive body becomes more prone to film and so forth, there is less margin for error regarding filming, and the service life of the photosensitive body is markedly shortened. Consequently, the detection and control of AC current must be performed very accurately.

Japanese Laid-Open Patent Application 2003-302813 proposes an image forming apparatus comprising a detection means for detecting two or more types of AC transmission output and charging AC current, with which the proper amount of charge is always applied and the amount of discharge does not rise, regardless of the combination of process cartridge and image forming apparatus main body. However, a problem is that when the charging roller and the power supply of the charging apparatus are far apart, stray capacity generates current in the power cable, and the original AC current and the current flowing into the stray capacity cannot be accurately detected, depending on the position of the means for detecting AC current produced by feedback current. Since this stray capacity varies with the environment, the harness cable routing, and so forth, it is difficult to estimate the inflow current that will be generated by stray capacity, so a problem is that filming cannot be prevented by quantitatively detecting the AC current.

### SUMMARY OF THE INVENTION

It is a first object of the present invention to provide a charging apparatus, process cartridge, and image forming apparatus with which fluctuations in the charging current can be suppressed, and image defects caused by filming and the like can be prevented, by specifying a permissible gap fluctuation value by quantitatively ascertaining the relationship between the fluctuation in charging current and the fluctuation in the gap between the photosensitive body and the charging roller.

It is a second object of the present invention to provide an image forming apparatus that is unaffected by stray capacity resulting from the environment, the harness cable routing, and so forth, and with which the AC current of a charging apparatus can be accurately detected and a photosensitive body can be charged more uniformly, the result of which is that no filming occurs on the photosensitive body over time.

A charging apparatus in accordance with the present invention comprises a charging roller provided at a minute gap away from an image carrier for performing charging. The relationship Gmax−Gmin≦30 (μm) is satisfied when the gap (μm) between the charged side of the image carrier and the charging side of the charging roller has a maximum value Gmax (μm) and a minimum value Gmin (μm).

A process cartridge that can be attached to and removed from the main body of an image forming apparatus in accordance with the present invention comprises an image carrier for carrying a latent image; and a charging device supported integrally with the image carrier, for uniformly charging the surface of the image carrier. The charging device is disposed at a minute gap away from the image carrier, and the relationship Gmax−Gmin≦30 (μm) is satisfied when the gap (μm) between the charged side of the image carrier and the charging side of the charging roller has a maximum value Gmax (μm) and a minimum value Gmin (μm).

An image forming apparatus in accordance with the present invention comprises an image carrier for carrying a latent image; a charging device for uniformly charging the surface of the image carrier; an exposure device for writing a latent image by exposing the surface of the charged image carrier on the basis of image data; a developing device for producing a visible image by supplying toner to the latent image formed on the image carrier surface; a transfer device for transferring the visible image on the image carrier surface to a transfer medium; and a cleaning device for cleaning the image carrier surface after transfer. The charging device is disposed at a minute gap away from the image carrier, and the relationship Gmax−Gmin≦30 (μm) is satisfied when the gap (μm) between the charged side of the image carrier and the charging side of the charging roller has a maximum value Gmax (μm) and a minimum value Gmin (μm).

An image forming apparatus in accordance with the present invention comprises a main body; an image carrier for carrying a latent image; a charging device for uniformly charging the surface of the image carrier; an exposure device for writing a latent image by exposing the surface of the charged image carrier on the basis of image data; a developing device for producing a visible image by supplying toner to the latent image formed on the image carrier surface; a transfer device for transferring the visible image on the image carrier surface to a transfer medium; a cleaning device for cleaning the image carrier surface after transfer; and a process cartridge that can be attached to and removed from the main body. The process cartridge includes the image carrier; and the charging device supported integrally with the image carrier. The charging device is disposed at a minute gap away from the image carrier, and the relationship Gmax−Gmin≦30 (μm) is satisfied when the gap (μm) between the charged side of the image carrier and the charging side of the charging roller has a maximum value Gmax (μm) and a minimum value Gmin (μm).

A toner in accordance with the present invention is used in an image forming apparatus, produced by subjecting a toner composition containing at least a polyester prepolymer having a nitrogen atom-containing functional group, a polyester, a colorant, and a parting agent to a crosslinking and/or extension reaction in the presence of resin microparticles in an aqueous solvent. The image forming apparatus comprises an image carrier for carrying a latent image; a charging device for uniformly charging the surface of the image carrier; an exposure device for writing a latent image by exposing the surface of the charged image carrier on the basis of image data; a developing device for producing a visible image by supplying toner to the latent image formed on the image carrier surface; a transfer device for transferring the visible image on the image carrier surface to a transfer medium; and a cleaning device for cleaning the image carrier surface after transfer. The charging device is disposed at a minute gap away from the image carrier, and the relationship Gmax−Gmin≦30 (μm) is satisfied when the gap (μm) between the charged side of the image carrier and the charging side of the charging roller has a maximum value Gmax (μm) and a minimum value Gmin (μm).

A toner in accordance with the present invention is used in an image forming apparatus, produced by subjecting a toner composition containing at least a polyester prepolymer having a nitrogen atom-containing functional group, a polyester, a colorant, and a parting agent to a crosslinking and/or extension reaction in the presence of resin microparticles in an aqueous solvent. The image forming apparatus comprises a main body; an image carrier for carrying a latent image; a charging device for uniformly charging the surface of the image carrier; an exposure device for writing a latent image by exposing the surface of the charged image carrier on the basis of image data; a developing device for producing a visible image by supplying toner to the latent image formed on the image carrier surface; a transfer device for transferring the visible image on the image carrier surface to a transfer medium; a cleaning device for cleaning the image carrier surface after transfer; and a process cartridge that can be attached to and removed from the main body. The process cartridge include the image carrier; and the charging device supported integrally with the image carrier. The charging device is disposed at a minute gap away from the image carrier, and the relationship Gmax−Gmin≦30 (μm) is satisfied when the gap (μm) between the charged side of the image carrier and the charging side of the charging roller has a maximum value Gmax (μm) and a minimum value Gmin (μm).

An image forming apparatus in accordance with the present invention comprises an image carrier for carrying a latent image; a charging device for uniformly charging the image carrier surface by superimposing an AC bias voltage over a DC bias voltage as the charging bias voltage; an AC current detection device for detecting alternating current flowing through the image carrier during application of the charging bias voltage; an exposure device for writing a latent image by exposing the surface of the charged image carrier on the basis of image data; a developing device for producing a visible image by supplying toner to the latent image formed on the image carrier surface; a transfer device for transferring the visible image on the image carrier surface to a transfer medium; a cleaning device for cleaning the image carrier surface after transfer; and a lubricant application device for applying a lubricant to the image carrier surface. The current detection device detects alternating current on the ground side of the image carrier.

A toner in accordance with the present invention is used in the developing step in an image forming apparatus of an electrophotographic process. The volume average particle diameter is from 3 to 8 μm, and the ratio·(Dv/Dn) of the volume average particle diameter (Dv) to the number average particle diameter (Dn) is between 1.00 and 1.40. The image forming apparatus comprises an image carrier for carrying a latent image; a charging device for uniformly charging the image carrier surface by superimposing an AC bias voltage over a DC bias voltage as the charging bias voltage; an AC current detection device for detecting alternating current flowing through the image carrier during application of the charging bias voltage; an exposure device for writing a latent image by exposing the surface of the charged image carrier on the basis of image data; a developing device for producing a visible image by supplying toner to the latent image formed on the image carrier surface; a transfer device for transferring the visible image on the image carrier surface to a transfer medium; a cleaning device for cleaning the image carrier surface after transfer; and a lubricant application device for applying a lubricant to the image carrier surface. The current detection devoce detects alternating current on the ground side of the image carrier.

### BRIEF DESCRIPTION OF THE DRAWINGS

The above and other objects, features, and advantages of the present invention will become more apparent from the following detailed description taken with the accompanying drawings, in which:

FIG. 1 is a diagram illustrating the simplified constitution of the image forming apparatus pertaining to the first and second embodiments of the present invention;

FIG. 2 is a diagram illustrating the simplified constitution of the image forming unit pertaining to the same image forming apparatus;

FIG. 3 is a cross section illustrating the constitution of the charging roller of the same image forming apparatus;

FIG. 4 is a diagram illustrating the method for maintaining a minute gap between the charging roller and the photosensitive body in the same;

FIG. 5 is a diagram of an example in which a spacer member is used to maintain this minute gap;

FIG. 6 is a diagram of an example in which a spacer member in the form of a flat-bottomed ring is used;

FIG. 7 is a diagram of an example in which a spacer member in the form of a round-bottomed ring is used;

FIG. 8 is a graph of the relationship between ΔGap and ΔI;

FIGS. 9A and 9B are diagrams schematically illustrating the shape of toner;

FIGS. 10A to 10C are diagrams illustrating the simplified external shape of the toner; and

FIG. 11 is a diagram illustrating the constitution of a power supply circuit and an AC current detection means of the charging apparatus in a second embodiment.

### DESCRIPTION OF THE PREFERRED EMBODIMENTS

Embodiments of the present invention will now be described in detail.

### First Embodiment

This embodiment is primarily intended to achieve the above-mentioned first object of the present invention.

This embodiment will now be described in detail through reference to the drawings.

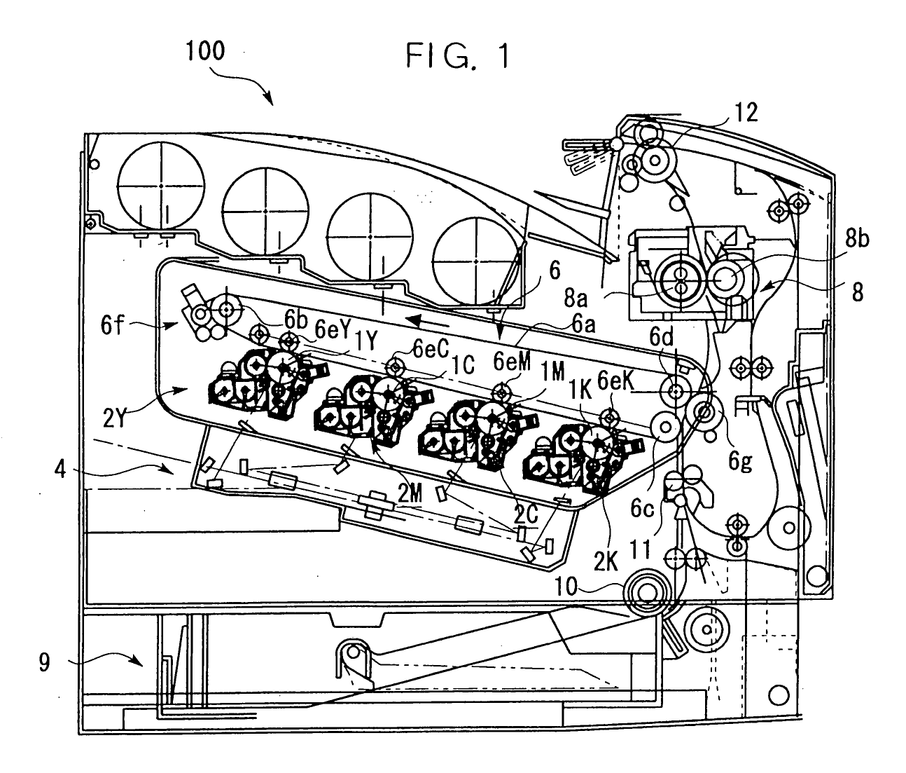

FIG. 1 illustrates the constitution of an image forming apparatus 100 pertaining to this embodiment. The description here will be for an example applied to the electrophotographic image forming apparatus 100.

This image forming apparatus 100 forms a color image from four colors of toner: yellow (hereinafter referred to as “Y”), cyan (hereinafter referred to as “C”), magenta (hereinafter referred to as “M”), and black (hereinafter referred to as “K”). The image forming apparatus 100 comprises four photosensitive bodies 1Y, 1C, 1M, and 1K serving as latent image carriers. The photosensitive bodies 1Y, 1C, 1M, and 1K are each rotated in the direction of the arrow in the drawing while in contact with an intermediate transfer belt 6a (surface movement member).

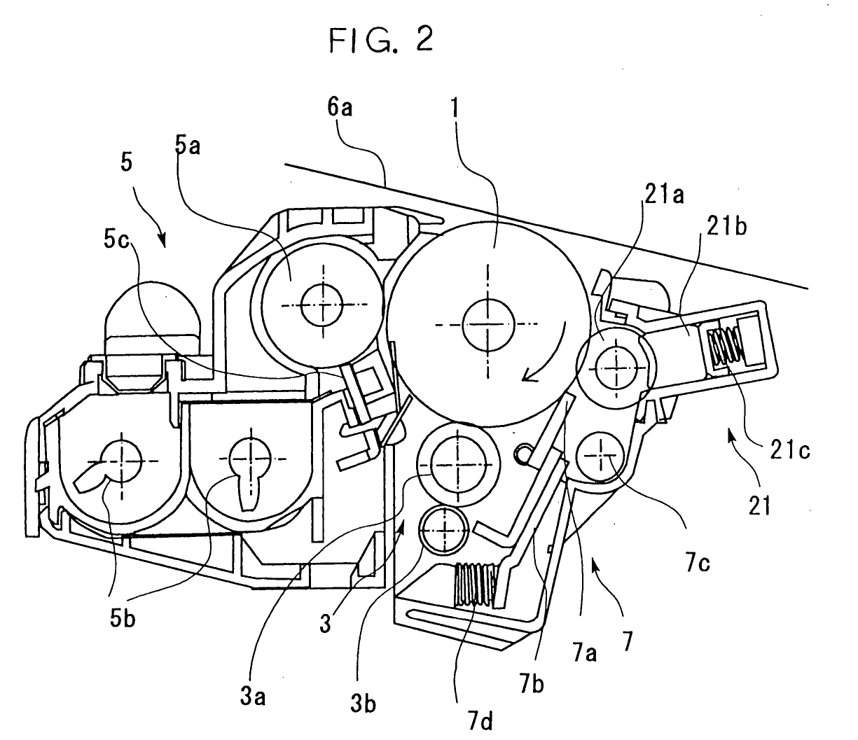

FIG. 2 illustrates the constitution of an image forming unit 2 equipped with a photosensitive body 1. The structure around the photosensitive bodies 1Y, 1C, 1M, and 1K of the image forming units 2Y, 2C, 2M, and 2K is the same for all of these, so only one image forming unit 2 is depicted, and the letters Y, C, M, and K used to differentiate by color are omitted. A developing apparatus 5 that forms visible toner images from latent images, a lubricant application apparatus 21 that applies a lubricant to the photosensitive body 1, a cleaning apparatus 7 that cleans off toner remaining on the photosensitive body 1, and a charging apparatus 3 that charges the photosensitive body 1 are disposed in that order around the photosensitive body 1, in the direction of movement of the surface thereof.

A developing roller 5a, which serves as a developer carrier, is partially exposed through an opening in the casing of the developing apparatus 5. A two-component developer composed of a toner and a carrier is used here, but a one-component developer containing no carrier may also be used. The developing apparatus 5 receives a supply of toner of the appropriate color from a toner bottle, and stores the toner inside. The developing roller 5a comprises a magnet roller (serving as a magnetic field generation means) and a developing sleeve that rotates coaxially around this magnet roller. The carrier in the developer is transported to the developing region across from the photosensitive body 1 in a state of having been attracted onto the developing roller 5a by the magnetic force generated by the magnet roller. In the region where it is across from the photosensitive body 1 (hereinafter referred to as the “developing region”), the surface of the developing roller 5a is moving in the same direction but at a higher linear velocity than the surface of the photosensitive body 1. The carrier attracted onto the developing roller 5a rubs against the surface of the photosensitive body 1 while the toner adhering to the carrier surface is supplied to the surface of the photosensitive body 1 and developed. At this point, a developing bias is applied from the power supply (not shown) to the developing roller 5a, which forms a developing electric field in the developing region.

The intermediate transfer belt 6a of a transfer apparatus 6 is in the form of an endless belt that goes around three support rollers 6b, 6c, and 6d and moves in the direction of the arrow in the drawing. The toner images on the photosensitive bodies 1Y, 1C, 1M, and 1K are electrostatically transferred and superimposed onto the intermediate transfer belt 6a. Electrostatic transfer includes a method involving a transfer charger, but the method employed here involves the use of a transfer roller 6e, which generates less transfer scattering. More specifically, primary transfer rollers 6eY, 6eC, 6eM, and 6eK are disposed as transfer apparatus 6 on the back side of the intermediate transfer belt 6a at the portions in contact with the photosensitive bodies 1Y, 1C, 1M, and 1K, respectively. A primary transfer region is formed by the photosensitive body 1 and the portion of the intermediate transfer belt 6a that is pressed on the by the primary transfer roller 6e. In transferring the toner images on the photosensitive bodies 1Y, 1C, 1M, and 1K onto the intermediate transfer belt 6a, a bias of positive polarity is applied to the primary transfer roller 6e. This forms a transfer electrical field in the region of each primary transfer (hereinafter referred to as transfer region), and causes the toner images on the photosensitive bodies 1Y, 1C, 1M, and 1K to be transferred by electrostatic adhesion onto the intermediate transfer belt 6a.

A belt cleaning unit 6f for removing any toner remaining on the surface of the intermediate transfer belt 6a is provided around this belt. This belt cleaning unit 6f comprises a fur brush and a cleaning blade for recovering any unnecessary toner adhering to the surface of the intermediate transfer belt 6a. The recovered unnecessary toner is transported by a transport means (not shown) from inside the belt cleaning unit 6f to a waste toner tank (not shown). The transfer belt 6a is a high-resistance, endless, single-layer belt with a volumetric resistivity of 10⁹ to 10¹¹ Ωcm. It is preferably made from PVDF (polyvinylidene fluoride), but may be made from a plurality of resin layers including an elastic layer.

A secondary transfer roller 6g is disposed in contact with the portion of the intermediate transfer belt 6a that goes around the support roller 6d. A secondary transfer region is formed between the intermediate transfer belt 6a and the secondary transfer roller 6g, and transfer paper (the recording member) is fed in at a specific timing to this portion. This transfer paper is housed in a paper feed cassette 9 located on the lower side of the exposure apparatus 4 in the drawing, and is transported to the second transfer region by a pickup roller 10, a pair of resist rollers 11, and so forth. The toner images superimposed on the intermediate transfer belt 6a are transferred all at once onto the transfer paper in the secondary transfer region. During this secondary transfer, a bias of positive polarity is applied to the secondary transfer roller 6g, and the toner image on the intermediate transfer belt 6a is transferred onto the transfer paper by the transfer electrical field thus formed.

The lubricant application apparatus 21 here mainly comprises a lubricant molding 21b housed in a fixed case, a brush-like roller 21a that is in contact with the lubricant molding 21b so as to brush up some lubricant and apply it to the photosensitive body 1, and a pressing spring 21c that presses against the brush-like roller 21a. The lubricant molding 21b is in cuboid form, and has a shape that extends in the axial direction of the photosensitive body 1. The lubricant molding 21b is biased by the pressing spring 21c toward the brush-like roller 21a so that nearly all of it can be used up. The lubricant molding 21b is a consumable and its thickness therefore decreases over time, but since it is pressed on by the pressing spring 21c, it is always in contact with the brush-like roller 21a.

The lubricant application apparatus 21 may be provided along with a cleaning blade 7a (the cleaning means) inside the cleaning apparatus 7. This allows any of the toner adhering to the brush that has been flicked downward by the lubricant molding 21b or a flicker as the brush-like roller 21a rubs against the photosensitive body 1 to be easily recovered.

Examples of lubricants include fatty acid metal salts, silicone oils, and fluororesins, which can be used singly or in mixtures of two or more types. A fatty acid metal salt is particularly favorable. The fatty acid metal salt is preferably one whose fatty acid is a straight-chain hydrocarbon. For example, myristic acid, palmitic acid, stearic acid, and oleic acid are favorable, with stearic acid being preferred. Examples of the metal include lithium, magnesium, calcium, strontium, zinc, cadmium, aluminum, cerium, titanium, and iron. Of these, zinc stearate, magnesium stearate, aluminum stearate, iron stearate, and the like are preferable, with zinc stearate being particularly favorable.

The lubricant may also be zinc stearate, calcium stearate, or the like that has been powderized, or may be a lubricant molding produced by coating a solid molding with fluorine particles.

The cleaning apparatus 7 comprises the cleaning blade 7a, a support member 7b, a toner recovery coil 7c, and a blade pressing spring 7d. The cleaning blade 7a removes any toner remaining on the photosensitive body 1 after transfer. It is affixed to the support member 7b and installed in the cleaning apparatus, and while there are no particular restrictions on the support member 7b, it can be made of metal, plastic, ceramic, or the like.

Examples of elastic materials with a low coefficient of friction that can be used as the cleaning blade 7a include urethane resins, silicone resins, and fluororesins, with urethane elastomers, silicone elastomers, and fluoroelastomers being examples thereof. The cleaning blade 7a is preferably made from a thermosetting urethane resin, and a urethane elastomer is particularly favorable in terms of wear resistance, ozone resistance, and soiling resistance. Elastomers also include rubbers. The hardness (JIS A) of the cleaning blade 7a is preferably between 65 and 85. Also, the cleaning blade 7a preferably has a thickness of 0.8 to 3.0 mm, and protrudes from 3 to 15 mm. Other conditions, such as the contact pressure, contact angle, and amount of indentation, can be suitably selected.

The charging apparatus 3 will now be described.

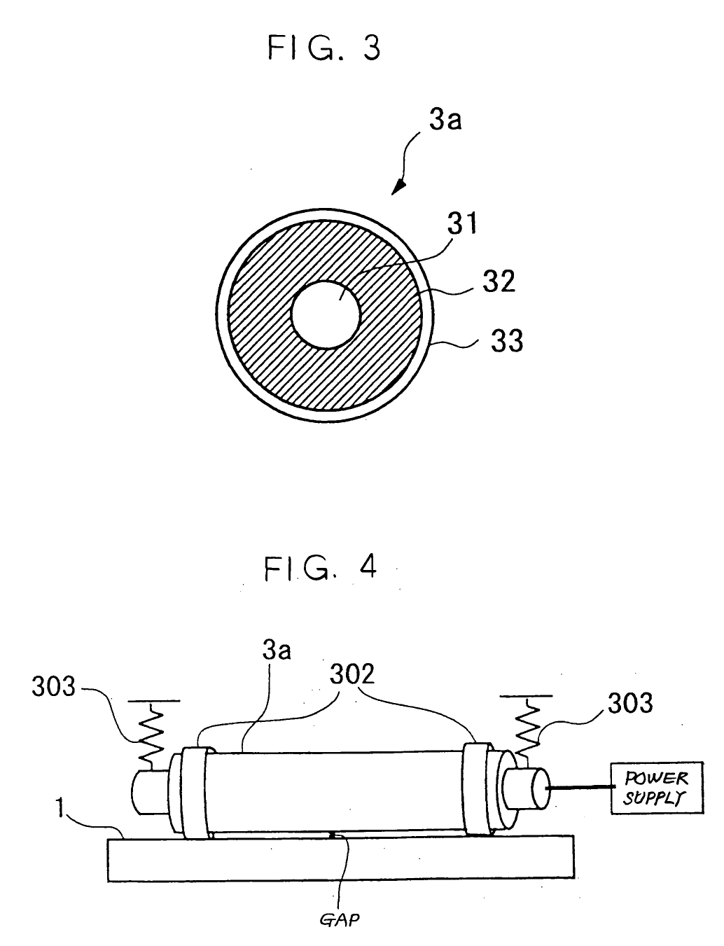

The charging apparatus 3 consists of a charging roller 3a (the charging member) disposed across from the photosensitive drum 1, and a charging cleaning member 3b disposed so as to be in contact with the opposite side from the side where the charging roller 3a is across from the photosensitive drum 1. FIG. 3 is a cross section of this charging roller. The charging roller 3a has a metal core 31 (electroconductive support) that is cylindrical in shape, a resistance adjustment layer 32 formed in a uniform thickness over the outer peripheral surface of the metal core 31, and a protective layer 33 that prevents leakage (as discussed below) by covering the surface of the resistance adjustment layer 32.

The resistance adjustment layer 32 is formed by providing a resin composition around the peripheral face of the metal core 31 by extrusion molding, injection molding, or the like. The JIS D hardness of the resistance adjustment layer 32 is to be at least 45 degrees in order to prevent the resistance adjustment layer 32 from deforming over time, which would change the gap between the photosensitive drum 1 and the charging roller 3a.

There are no particular restrictions on the thermoplastic resin used for the resistance adjustment layer 32 so long as the JIS D hardness can be maintained after molding, but the use of polyethylene (PE), polypropylene (PP), polymethyl methacrylate (PMMA), polystyrene (PS), copolymers thereof (such as AS and ABS), and other such widely used resins is preferred because they can be easily molded.

The resistance adjustment layer 32 is molded from a thermoplastic resin composition in which a macromolecular ion conductor has been dispersed. The volumetric resistivity of this resistance adjustment layer 32 is preferably between 10⁶ and 10⁹ Ω·cm. If the volumetric resistivity is over 10⁹ Ω·cm, the amount of charging will be inadequate and it will be impossible to obtain a charge potential sufficient to produce a uniform image on the photosensitive drum 1, but if the volumetric resistivity is under 10⁶ Ω·cm, there will be leakage to the entire photosensitive drum 1.

The macromolecular ion conductor that is dispersed in this thermoplastic resin is one whose resistance by itself is from 10⁶ to 10⁹ Ω·cm and readily lowers the resistance of the resin. Examples include compounds containing a polyether ester amide component. The added amount thereof is preferably from 30 to 70 weight parts per 100 weight parts substrate in order to adjust the resistance of the resistance adjustment layer 32 to the desired value.

A macromolecular compound containing quaternary ammonium salt groups can also be used as the macromolecular ion conductor. An example is a polyolefin containing a quaternary ammonium salt group. The added amount thereof is preferably from 10 to 40 weight parts per 100 weight parts substrate in order to adjust the resistance of the resistance adjustment layer 32 to the desired value.

The dispersal of the macromolecular ion conductor in the thermoplastic resin can be easily accomplished by using a biaxial kneader, a regular kneader, or the like. Since an ion conductive material disperses uniformly at the molecular level in a matrix polymer, the resistance adjustment layer 32 is not subject to the variance in resistance value that accompanies poor dispersion of the conductive substance as seen in resistance adjustment layers in which a conductive pigment has been dispersed. Also, since the ion conductive material is a macromolecular compound, it is uniformly dispersed and fixed in the matrix polymer, making it less likely to bleed out.

The protective layer 33 is formed so as to have a higher resistance than the resistance adjustment layer 32, thereby avoiding leakage at defects onto the photosensitive drum 1. If the resistance of the protective layer 33 is too high, though, charging efficiency will decrease so the difference between the resistance of the protective layer 33 and the resistance of the resistance adjustment layer 32 is preferably no more than 10³ Ω·cm.

It is good for the material that forms the protective layer 33 to be a resin material because it will be easy to manufacture a film. This resin material is preferably a fluororesin, polyamide resin, polyester resin, or polyvinyl acetal resin because it will be non-adhesive and toner will not adhere thereto. Also, a resin material generally is electrically insulating, so if the protective layer 33 is formed from a resin material alone, it will not be able to serve as a charging roller. In view of this, the resistance of the protective layer 33 is adjusted by dispersing various kinds of conductor into the above-mentioned resin material. Further, an isocyanate or other such reaction curing agent may be dispersed in the resin material to enhance bonding between the protective layer 33 and the resistance adjustment layer 32.

The charging roller 3a is connected to a power supply, and a specific voltage is applied thereto. This voltage may be direct current (DC) voltage alone, but is preferably voltage consisting of alternating current (AC) voltage superimposed over DC voltage. Applying AC voltage allows the surface of the photosensitive drum 1 to be charged more uniformly. In this embodiment, AC voltage is superimposed over DC voltage.

The charging roller 3a is installed at a minute gap away from the photosensitive drum 1. This minute gap can be set, for example, by winding a spacer member having a specific thickness around the non-image formation regions at the ends of the charging roller 3a, and bringing the surface of the spacer members into contact with the surface of the photosensitive drum 1. As shown in FIG. 4, the spacer member here comprises films 302 wound around the ends of the charging roller. These spacers 302 are in contact with the photosensitive surface of the photosensitive body, and maintain a constant, minute gap in the image regions of the charging roller and the photosensitive body. The applied bias comprises an AC-superimposed type of voltage being applied, and the discharge produced at the minute gap between the charging roller and the photosensitive body charges the photosensitive body. Furthermore, pressing on the shaft with a spring 303 or the like increases the precision at which the minute gap is maintained.

Furthermore, the gap member may be molded integrally with the charging roller. In this case at least the surface of the gap portion is to be an insulator. Doing this eliminates discharge at the gap portion, so discharge product builds up in the gap portion, the adhesiveness of the discharge product affixes the toner to the gap portion, and the gap does not become wider.

A heat-shrinkable tube may also be used as the gap member. An example of a heat-shrinkable tube is the 105° C.-use Sumi Tube (trade name: F 105° C., made by Sumitomo Chemical). The thickness of the Sumi Tube is 300 μm, and this heat-shrinkable tube exhibits shrinkage of about 50 to 60%, although this will vary with the diameter of the charging member being mounted. Since heat shrinkage results in an increase in thickness of about 0 to 200 μm, the machining of the charging member will have to include this increased amount. For example, when a spacer member is to be mounted on a charging member with a diameter of 12 mm, the machining depth will be 350 μm, and a heat-shrinkable tube with an inside diameter of about 15 mm is used. After the heat-shrinkable tubes have been mounted to the machined part of the charging member ends, the charging member is rotated and the tubes are uniformly shrunken while being heated by a heat source of 120 to 130° C. toward the inside from the ends, allowing the space between the charging member and the photosensitive body to be set at about 50 μm. Once fixed by heat fusion, the heat-shrinkable tubes will not come off during use, but as a preventative measure, a small amount of a liquid adhesive such as a cyanoacrylate resin (such as Aron Alpha or Cyanobond, both trademarks) can be applied to the ends to provide a more secure fix.

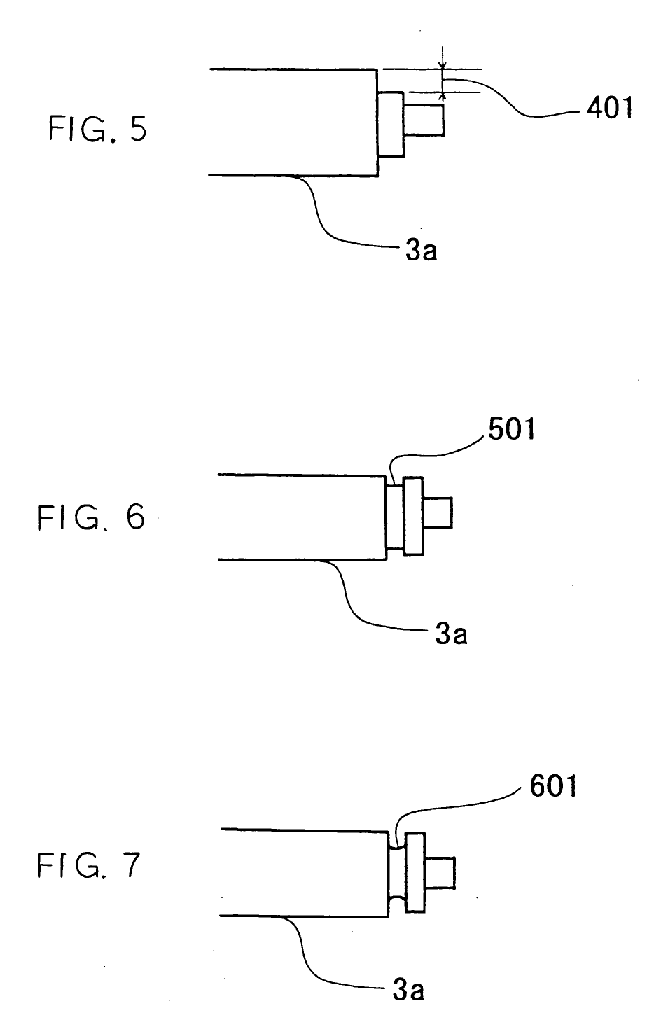

Since the heat-shrinkable tubes have some thickness to them, when they are used as the spacer member, as shown in FIG. 5, a step 401 is created to make room for the mounting of the spacer member, or as shown in FIG. 6, a groove 501 is formed, leaving part of the end part of the resistance layer, and an endless, stretchable, flat-bottomed ring-shaped spacer member is fitted into this groove, or as shown in FIG. 7, a round-bottomed groove 601 is formed, and a round ring-shaped (usually called an O-ring) spacer member is fitted into the groove. The ends are preferably machined down in size to make it easier to slip on the spacer member, or the ends can be completely cut off and the spacer member affixed with an adhesive. When the spacer member is installed in a flat- or round-bottomed groove, it is preferable to use either the above-mentioned liquid adhesive, or a two-part epoxy resin or other such adhesive.

The spacer member may also be a roller member that is larger in diameter than the charging roller and is inserted afterwards.

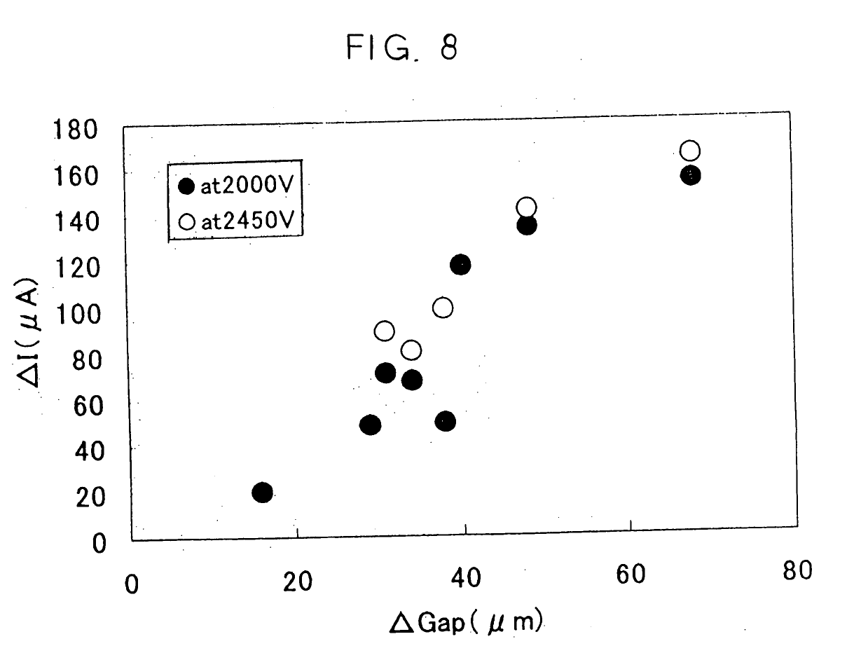

FIG. 8 is a graph, obtained experimentally, of the relation between ΔGap, which is obtained by subtracting the minimum value from the maximum value of the gap of the charging roller 3a, and ΔI, which is the fluctuation in current at this time. The charging roller 3a has tape wound around its two ends, and these ends are biased by a pressing spring toward the photosensitive body 1. A voltage Vpp, comprising AC voltage superimposed over DC voltage, is applied in two different levels (2000 V and 2450 V) to the charging roller 3a, the gap between the charging roller and the photosensitive body is varied, and the current value I at each point is measured.

It can be seen from FIG. 8 that the relation between ΔGap and ΔI is substantially linear. Therefore, if ΔGap can be quantitatively ascertained, it will be possible to restrict the current value at which filming and the like occur. In this experiment, filming and so forth were seen on the photosensitive body surface when ΔI exceeded 50 μA. ΔGap at this point was over 40 μm. Therefore, if ΔGap is set to 30 μm or less, ΔI can be kept 50 μA or less and the filming and so forth that occur on the photosensitive body surface can be suppressed.

The charging apparatus 3 in the example described above can be a process cartridge that integrally supports the photosensitive body 1 and is formed so as to be removable from the image forming apparatus main body. The process cartridge may also comprise the developing apparatus 5 and/or the cleaning apparatus 7. With this process cartridge, filming and so forth on the surface of the photosensitive body can be suppressed, so the resulting process cartridge does not cause any deterioration in image quality.

The use of a process cartridge is also advantageous in terms of maintenance. Should a malfunction occur in the charging apparatus 3 and the developing apparatus 5 and/or the cleaning apparatus 7 or the like, the apparatus can be quickly restored to its original condition merely by replacing the cartridge, so servicing takes less time. Also, suppressing the filming and so forth of the electrophotographic photosensitive body greatly helps to extend the service life of the process cartridge.

The effect of installing the charging apparatus 3 of this embodiment is most pronounced in an image forming apparatus in which the toner used by the developing apparatus 5 has high circularity (an average circularity of at least 0.93). Therefore, when this charging apparatus 3 is used to quantitatively limit the gap between the charging roller 3a and the surface of the photosensitive body 1, the occurrence of filming and the like on the surface of the photosensitive body 1 can be suppressed, and the surface of the photosensitive body 1 will not be subjected to the damage that accompanies abnormal current levels.

A spherical toner can be defined by the following shape factors SF-1 and SF-2. The toner used in this image forming apparatus is one whose shape factor SF-1 is from 100 to 180, and whose shape factor SF-2 is from 100 to 180.

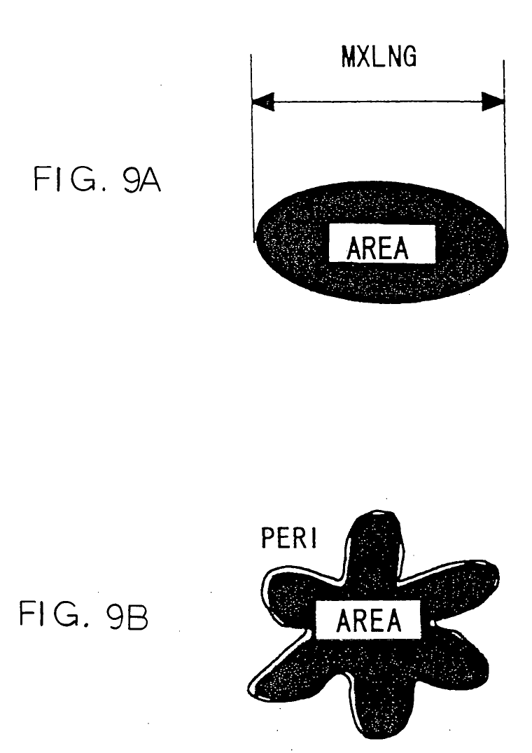

FIGS. 9A and 9B schematically illustrate the shape of toner for the sake of describing the shape factors SF-1 and SF-2, respectively. The shape factor SF-1 indicates the proportion of roundness of the toner shape, and is expressed by the following Equation 1. This value is obtained by dividing the square of the maximum length MXLNG of the shape resulting when the toner is projected onto a two-dimensional surface by the figure area AREA, and multiplying this quotient by 100n/4.
SF-1={(MXLNG)²/AREA}×(100n/4) Eq. 1

The shape of the toner when the value of SF-1 is 100 is that of a true sphere, and becomes more amorphous as the value of SF-1 increases.

The shape factor SF-2 indicates the proportion of irregularity in the shape of the toner, and is expressed by the following Equation 2. This value is obtained by dividing the square of the perimeter PERI of the figure resulting when the toner is projected onto a two-dimensional surface by the figure area AREA, and multiplying this quotient by 100n/4.
SF-2={(PERI)²/AREA}×(100n/4) Eq. 2

There are no irregularities on the surface of the toner when the value of SF-2 is 100, and the irregularities on the surface of the toner become more pronounced as the value of SF-2 increases.

As the shape of the toner approaches spherical, the contact between toner particles, or between the toner and the photosensitive body 1, moves closer to being point contact, the adsorptive force between toner particles weakens, and fluidity therefore rises. Also, the adsorptive force between the toner and the photosensitive body 1 weakens, and the transfer proportion rises. On the other hand, spherical toner particles more readily enter the gap between the photosensitive body 1 and the cleaning blade 7a, so the shape factors SF-1 and SF-2 of the toner should not be too small.

The shape factors were measured as follows. The toner was photographed with a scanning electron microscope (S-800, made by Hitachi), and this photograph was placed in an image analyzer (Lusex 3, made by Nireco) and analyzed, and the shape factor was calculated.

If SF-1 and SF-2 are too large, the toner will scatter on the image and there will be a drop in image quality, so it is preferable if neither SF-1 nor SF-2 exceeds 180.

The volume average particle size of the toner is from 3 to 8 μm, and good cleaning will be obtained even if the toner has a small particle size and a particle size distribution in which the ratio (Dv/Dn) of the volume average particle diameter (Dv) to the number average particle diameter (Dn) is between 1.00 and 1.40. Narrowing the particle size distribution of the toner results in a more uniform charge quantity distribution, allows a high-quality image with little substrate fogging to be obtained, and also affords a higher transfer efficiency. Further, since the content of external additive microparticles in the toner tends to be relatively high when the particle size is small, these tend to separate from the toner and cause filming on the photosensitive body. However, with the charging apparatus pertaining to this embodiment, the ΔGap between the charging roller and the surface of the photosensitive body is limited, the result of which is that the occurrence of abnormal current is suppressed and less filming occurs.

A toner that can be used favorably in the image forming apparatus of this embodiment is one obtained by dissolving or dispersing at least a polyester prepolymer having a nitrogen atom-containing functional group, a polyester, a colorant, and a parting agent in an organic solvent, and subjecting the resulting toner material liquid to a crosslinking and/or extension reaction in an aqueous solvent. The materials constituting the toner, and the method for manufacturing the toner, will now be described.

Modified Polyester

The toner of this embodiment includes a modified polyester (i) as a binder resin. “Modified polyester” (i) here refers to a state in which a bond group other than an ester bond is present in a polyester resin, and a resin component with a different constitution is bonded by a covalent bond, ion bond, or the like in the polyester resin. More specifically, it refers to the modification of polyester terminals by introducing to the polyester terminals an isocyanate group or other functional group that will react with a carboxylic group and a hydroxyl group, and then reacting with a compound containing active hydrogen.

Examples of the modified polyester (i) include urea-modified polyesters obtained by reaction between a polyester prepolymer (A) having an isocyanate group and an amine (B). An example of the polyester prepolymer (A) having an isocyanate group is a polycondensate of a polyol (PO) and a polycarboxylic acid (PC), obtained by reacting a polyester having an active hydrogen group with a polyisocyanate compound (PIC). Examples of the active hydrogen group had by the polyester include hydroxyl groups (alcoholic hydroxyl groups and phenolic hydroxyl groups), amino groups, carboxyl groups, and mercapto groups. Of these, an alcoholic hydroxyl group is preferred.

A urea-modified polyester is produced as follows.

Examples of the polyol (PO) include diols (DIO) and triols and higher polyols (TO), with DIO alone or a mixture of DIO and a small amount of TO being preferable. Examples of dihydric alcohols (DIO) include alkylene glycols (such as ethylene glycol, 1,2-propylene glycol, 1,3-propylene glycol, 1,4-butanediol, and 1,6-hexanediol); alkylene ether glycols (such as diethylene glycol, triethylene glycol, dipropylene glycol, polyethylene glycol, polypropylen glycol and polytetramethylene ether glycol); alicyclic diols (such as 1,4-cyclohexanedimethanol and hydrogenated bisphenol A); bisphenols (such as bisphenol A, bisphenol F, and bisphenol S); adducts of the alicyclic diols mentioned above with an alkylene oxide (such as ethylene oxide, propylene oxide, and butylene oxide); and adducts of the bisphenols mentioned above with an alkylene oxide (such as ethylene oxide, propylene oxide and butylene oxide). Of these, C₂ to C₁₂ alkylene glycols and alkylene oxide adducts of bisphenols are preferable. An alkylene oxide adduct of a bisphenol, or a mixture of alkylene oxide adduct of a bisphenol and a C₂ to C₁₂ alkylene glycol is particularly favorable. Examples of triols and higher polyols (TO) include aliphatic polyols having a valence of 3 to 8 (such as glycerol, trimethylolethane, trimethylolpropane, pentaerythritol, and sorbitol); trihydric and higher phenols (such as trisphenol PA, phenol novolac, and cresol novolac); and alkylene oxide adducts of the polyphenols mentioned above.

Examples of the polycarboxylic acid (PC) include dicarboxylic acids (DIC) and trivalent and higher polycarboxylic acids (TC), with DIC alone or a mixture of DIC and a small amount of TC being preferable. Examples of dicarboxylic acids (DIC) include alkylenedicarboxylic acids (such as succinic acid, adipic acid, and sebacic acid); alkenylenedicarboxylic acids (such as maleic acid and fumaric acid); and aromatic dicarboxylic acids (such as phthalic acid, isophthalic acid, terephthalic acid, and naphthalenedicarboxylic acid). Of these, C₄ to C₂₀ alkenylenedicarboxylic acids and C₈ to C₂₀ aromatic dicarboxylic acids are preferable. Examples of trivalent and higher polycarboxylic acids (TC) include C₉ to C₂₀ aromatic polycarboxylic acids (such as trimellitic acid and pyromellitic acid). The polycarboxylic acid (PC) may also be produced by reacting anhydrides or lower alkyl esters (such as methyl esters, ethyl esters, or isopropyl esters) of the above compounds with a polyol (PO).

The ratio of polyol (PO) to polycarboxylic acid (PC), as the equivalence ratio OH/COOH of hydroxyl groups (OH) to carboxyl groups (COOH), is usually from 2/1 to 1/1, and preferably from 1.5/1 to 1/1, and even more preferably from 1.3/1 to 1.02/1.

Examples of polyisocyanate compounds (PIC) include aliphatic polyisocyanates (such as tetramethylene diisocyanate, hexamethylene diisocyanate, and 2,6-diisocyanate methyl caproate); alicyclic polyisocyanates (such as isophorone diisocyanate and cyclohexylmethane diisocyanate); aromatic diisocyanates (such as tolylene diisocyanate and diphenylmethane diisocyanate); aromatic aliphatic diisocyanates (such as α,α,α′,α′-tetramethyl xylylene diisocyanate); isocyanates; and blocked polyisocyanates in which the polyisocyanates mentioned above have been blocked with a phenol derivative, an oxime, or a caprolactam. These compounds can also be used in combinations of two or more types.

The proportion of polyisocyanate compound (PIC), as the equivalence ratio NCO/OH of isocyanate groups (NCO) to hydroxyl groups (OH) of the polyester having a hydroxyl group, is usually from 5/1 to 1/1, and preferably from 4/1 to 1.2/1, and even more preferably from 2.5/1 to 1.5/1. Low-temperature fixability will suffer if NCO/OH is over 5. If the NCO molar ratio is less than 1, then when a urea-modified polyester is used, the urea content in that polyester will be low, resulting in inferior hot offset resistance.

The content of the polyisocyanate compound (PIC) constitutional component in the polyester prepolymer (A) having an isocyanate group is usually from 0.5 to 40 wt %, and preferably from 1 to 30 wt %, and even more preferably from 2 to 20 wt %. If the content is less than 0.5 wt %, hot offset resistance will suffer, and this is also disadvantageous in terms of both high temperature storage stability and low-temperature fixability. Low-temperature fixability will decrease if 40 wt % is exceeded, however.

The number of isocyanate groups included per molecule of the polyester prepolymer (A) having an isocyanate group is usually at least 1, and preferably from 1.5 to 3 on average, and even more preferably from 1.8 to 2.5 on average. If there is fewer than 1 per 1 molecule, the molecular weight of the urea-modified polyester will decrease and hot offset resistance will suffer.

Examples of the amine (B) that is reacted with the polyester prepolymer (A) include diamine compounds (B1), triamine and higher polyamine compounds (B2), amino alcohols (B3), aminomercaptans (B4), amino acids (B5), and blocked amines (B6) in which the amines B1 to B5 are blocked.

Examples of the diamine compounds (B1) include aromatic diamines (such as phenylenediamine, diethyltoluenediamine, and 4,4′-diaminodiphenylmethane); alicyclic diamines (such as 4,4′-diamino-3,3′-dimethyldicyclohexylmethane, diaminocyclohexane, and isophoronediamine); and aliphatic diamines (such as ethylenediamine, tetramethylenediamine, and hexamethylenediamine). Examples of the triamine and higher polyamine compounds (B2) include diethylenetriamine and triethylenetetramine. Examples of the amino alcohols (B3) include ethanolamine and hydroxyethylaniline. Examples of the aminomercaptans (B4) include aminoethylmercaptan and aminopropylmercaptan. Examples of the amino acids (B5) include aminopropionic acid and aminocaproic acid. Examples of the blocked amines (B6) in which the amines B1 to B5 are blocked include ketimine compounds which obtained from one of the amines B1 to B5 and a ketone (such as acetone, methyl ethyl ketone, and methyl isobutyl ketone), and oxazolidine compounds. Of these amines (B), B1 and mixtures of B1 and a small amount of B2 are preferable.

The proportion of the amines (B), as the equivalence ratio NCO/NHx of the isocyanate groups (NCO) in the polyester prepolymer (A) having an isocyanate group to the amine groups (NHx) in the amine (B) is usually from 1/2 to 2/1, and preferably from 1.5/1 to 1/1.5, and even more preferably from 1.2/1 to 1/1.2. If NCO/NHx is either greater than 2 or less than ½, the molecular weight of the urea-modified polyester will decrease and hot offset resistance will suffer.

The urea-modified polyester may contain urethane bonds as well as urea bonds. The molar ratio (urea/urethane) of the urea bonds to the urethane bonds is usually from 100/0 to 10/90, and preferably from 80/20 to 20/80, and even more preferably from 60/40 to 30/70. Hot offset resistance will suffer if the molar ratio of urea bonds is less than 10%.

The urea-modified polyester (i) used in this embodiment can be manufactured by a one-shot method or a prepolymer method. The weight average molecular weight of the urea-modified polyester (i) is usually at least 10,000, and preferably from 20,000 to 10,000,000, and even more preferably from 30,000 to 1,000,000. The peak molecular weight here is preferably from 1000 to 10,000; below 1000, the extension reaction will not proceed well, the toner will have little elasticity, and as a result the hot offset resistance will suffer. If 10,000 is exceeded, though, there will be a decrease in fixability, and manufacturing problems will be encountered in the course of producing particles or a powder. There are no particular restrictions on the number average molecular weight of the modified polyester (i) when an unmodified polyester (ii) (discussed below) is used, and the number average molecular weight may be one that will make it easy to achieve the above-mentioned weight average molecular weight. When (i) is used alone, the number average molecular weight is usually 20,000 or less, and preferably from 1000 to 10,000, and even more preferably from 2000 to 8000. Exceeding 20,000 will adversely affect low-temperature fixability, and gloss will decrease when a full-color apparatus is used.

The molecular weight of the resulting urea-modified polyester can be adjusted by using a reaction stopper as needed in the crosslinking and/or extension reaction of the polyester prepolymer (A) and the amine (B) used for obtaining the modified polyester (i). Examples of this reaction stopper include monoamines (such as diethylamine, dibutylamine, butylamine, and laurylamine) and blocked amines (such as ketimine compounds) prepared by blocking these monoamines.

The molecular weight of the produced polymer can be measured by gel permeation chromatography (GPC), using THF as the solvent.

Unmodified Polyester

In this embodiment, the modified polyester resin (i) can be used alone, or an unmodified polyester resin (ii) can be contained along with (i) as a binder resin component. Using (i) and (ii) together is preferable over using (i) alone because low-temperature fixability will be improved and, in addition, gloss will be increased when a full-color apparatus is used. Examples of the unmodified polyester resin (ii) include the same polycondensates of a polyol (PO) with a polycarboxylic acid (PC) as in the polyester components of (i) above, and preferred examples are also the same. In addition to being just an unmodified polyester, (ii) may also be a polyester that has been modified with chemical bonds other than urea bonds, such as one modified with urethane bonds. In terms of low-temperature fixability and hot offset resistance, it is preferable for (i) and (ii) to be at least partially compatibly blended. Therefore, it is preferable for (ii) to have a composition similar to that of the polyester component of (i). The weight ratio of (i) to (ii) when (ii) is contained is usually from 5/95 to 80/20, and preferably from 5/95 to 30/70, and even more preferably from 5/95 to 25/75, with from 7/93 to 20/80 being particularly favorable. Hot offset resistance will suffer if the weight ratio of (i) is less than 5%, and this is also disadvantageous in terms of both high temperature storage stability and low-temperature fixability.

The peak molecular weight of (ii) is usually from 1000 to 10,000, and preferably from 2000 to 8000, and even more preferably from 2000 to 5000. High temperature storage stability will suffer below 1000, but low-temperature fixability will decrease if 10,000 is exceeded. It is preferable for (ii) to have a hydroxy value of at least 5, and preferably from 10 to 120, and even more preferably from 20 to 80. A value under 5 is disadvantageous in terms of both high temperature storage stability and low-temperature fixability. The acid value of (ii) is preferably from 1 to 5, and even more preferably from 2 to 4. Since a wax with a high acid value is used, a binder with a low acid value will lead to charging and high volumetric resistance, so it is easy to match to a toner used in a two-component developer.

The binder resin usually has a glass transition point (Tg) of from 35 to 70° C., and preferably from 55 to 65° C. The high temperature storage stability of the toner will decrease under 35° C., but low-temperature fixability will be inadequate over 70° C. Since the urea-modified polyester tends to be present on the surface of the resulting toner matrix particles, the toner of the present invention tends to have better high temperature storage stability than a conventional polyester-based toner even though its glass transition point is lower.

The glass transition point (Tg) can be measured by differential scanning calorimeter (DSC).

Colorant

All known dyes and pigments can be used as the colorant, examples of which include carbon black, nigrosine dyes, black iron oxide, Naphthol Yellow S, Hansa Yellow (10G, 5G, and G), Cadmium Yellow, yellow iron oxide, loess, chrome yellow, Titan Yellow, polyazo yellow, Oil Yellow, Hansa Yellow (GR, A, RN, and R), Pigment Yellow L, Benzidine Yellow (G and GR), Permanent Yellow (NCC), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL, and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluldine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, and mixtures of these. The colorant is usually contained in the toner in an amount of 1 to 15 wt %, and preferably 3 to 10 wt %.

The colorant can also be used as a master batch that is compounded with a resin. Examples of the binder resin used in the manufacture of the master batch or kneaded along with the master batch include the styrene polymers and substituted styrene polymers such as polystyrene, poly-p-chlorostyrene, and polyvinyltoluene; copolymers of these and vinyl compounds; and other resins such as polymethyl methacrylate, polybutyl methacrylate, polyvinyl chloride, polyvinyl acetate, polyethylene, polypropylene, polyester, epoxy resins, epoxy polyol resins, polyurethane, polyamide, polyvinylbutyral, polyacrylic acid resins, rosin, modified rosin, terpene resins, aliphatic and alicyclic hydrocarbon resins, aromatic petroleum resins, chlorinated paraffin, and paraffin wax. These can be used singly or in mixtures.

Charge Control Agent

Any known charge control agent can be used, examples of which include nigrosine dyes, triphenylmethane dyes, chromium-containing metal complex dyes, molybdic acid chelate pigments, rhodamine dyes, alkoxyamines, quaternary ammonium salts (including fluorine-modified quaternary ammonium salts), alkylamides, phosphorus (either alone or in compounds), tungsten (either alone or in compounds), fluorine-containing activators, metal salts of salicylic acid, and metal salts of salicylic acid derivatives. Specific examples include Bontron 03 (nigrosine dye), Bontron P-51 (quaternary ammonium salt), Bontron S-34 (metal-containing azo dye), E-82 (metal complex of oxynaphthoic acid), E-84 (metal complex of salicylic acid), and E-89 (phenol-based condensate), all of which are made by Orient Chemical Industries; TP-302 and TP-415 (molybdenum complexes of a quaternary ammonium salt), which are made by Hodogaya Chemical; Copy Charge PSY VP2038 (quaternary ammonium salt), Copy Blue (triphenylmethane derivative), Copy Charge NEG VP2036 and NX VP434 (quaternary ammonium salts), all of which are made by Hoechst; LRA-901 and LR-147 (the latter a boron complex), which are made by Japan Carlit; and copper phthalocyanine, perylene, quinacridone, azo pigments, and macromolecular compounds having a functional group such as a sulfonate group, a carboxyl group, or a quaternary ammonium group. Of these, the use of a substance that controls the toner to have negative polarity is particularly favorable.

The amount in which the charge control agent is used is determined by the kind of the binder resin used, whether or not an additive is used, and the toner manufacturing method (including the dispersion method), and therefore cannot be unconditionally specified, but this amount is preferably from 0.1 to 10 weight parts per 100 weight parts binder resin. A range of from 0.2 to 5 weight parts is particularly good. If the amount is over 10 weight parts, the chargeability of the toner will be too great, reducing the effect of the charge control agent, increasing the electrostatic attraction force of the developing roller, decreasing the fluidity of the toner, and leading to a decrease in image density.

Parting Agent

The low-melting wax with a melting point of from 50 to 120° C. used as the parting agent serves more effectively as a parting agent at the interface between the fixing roller and the toner in the dispersal of the binder resin, and as a result, hot offset resistance can be improved without applying a parting agent such as an oil to the fixing roller. Examples of this parting agent include natural waxes such as vegetable waxes (such as carnauba wax, cotton wax, Japan wax, and rice wax); animal waxes (such as beeswax and lanolin); mineral waxes (such as ozokelite and ceresine); and petroleum waxes (such as paraffin, microcrystalline wax, and petrolatum. In addition, synthesized waxes can also be used, examples of which include synthetic hydrocarbon waxes such as Fischer-Tropsch waxes and polyethylene waxes, and synthetic waxes such as esters, ketones, and ethers. In addition, it is possible to use fatty acid amides such as 1,2-hydroxylstearic acid amide, stearic acid amide, phthalic anhydride imide, and chlorinated hydrocarbons; and polyacrylate homopolymers (such as poly-n-stearyl methacrylate and poly-n-lauryl methacrylate) or copolymers (such as n-stearyl acrylate-ethyl methacrylate) having a long alkyl group in their side chain, which are all low-molecular weight crystalline macromolecular resins.

The charge control agent and parting agent can be melt-kneaded along with the master batch and binder resin, but of course may instead be added during dissolution or dispersion in an organic solvent.

External Additive

Inorganic particles are preferably used as an external additive for enhancing the fluidity, developing, and charging of the toner particles. The primary particle size of these inorganic particles is preferably from 5×10⁻³ to 2 μm, and even more preferably from 5×10⁻³ to 0.5 μM. It is also preferable for the specific surface area of as measured by BET method to be from 20 to 500 m²/g. The proportion in which these inorganic particles are used is preferably from 0.01 to 5 wt %, and even more preferably from 0.01 to 2.0 wt %, with respect to the toner.

Specific examples of inorganic particles include silica, alumina, titanium oxide, barium titanate, magnesium titanate, calcium titanate, strontium titanate, zinc oxide, tin oxide, quartz sand, clay, mica, sand-lime, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. It is especially good for hydrophobic silica microparticles and hydrophobic titanium oxide microparticles to be used together as a fluidity imparting agent. In particular, when stirring and mixing are performed using these two microparticles each having an average particle size of 5×10⁻² μm or less, the electrostatic force and van der Waals' force between the external additive and the toner are markedly improved, and as a result, the fluidity imparting agent will not fall out of the toner during stirring and mixing inside the developing apparatus performed in order to achieve the desired charging level, good image quality will be obtained with no defects such as white spots, and less toner will remain behind after transfer.

Titanium oxide microparticles have excellent environmental stability and image density stability, but the charging rise characteristics tend to deteriorate, and if titanium oxide microparticles are added in a larger amount than silica microparticles, this side effect is believed to become pronounced. However, if hydrophobic silica microparticles and hydrophobic titanium oxide microparticles are added in amounts between 0.3 and 1.5 wt %, the charging rise characteristics will not be affected too adversely, and the desired charging rise characteristics will be obtained, that is, stable image quality will be obtained over repeated copying.

The method for manufacturing the toner will now be described. A preferred manufacturing method is given here, but other methods may also be employed.

Method for Manufacturing Toner

1) A toner material liquid is produced by dispersing a colorant, an unmodified polyester, a polyester prepolymer having an isocyanate group, and a parting agent in an organic solvent. The solvent is preferably volatile and has a boiling point lower than 100° C., as this will make it easier to remove the solvent after the formation of the toner matrix particles. Specific examples of such solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone, which can be used singly or in combinations of two or more types. It is particularly favorable to use an aromatic solvent such as toluene or xylene, or a halogenated hydrocarbon such as methylene chloride, 1,2-dichloroethane, chloroform, or carbon tetrachloride. The organic solvent is usually added in an amount of 0 to 300 weight parts, and preferably 0 to 100 weight parts, and even more preferably 25 to 70 weight parts, per 100 weight parts polyester prepolymer.

2) The toner material liquid is emulsified in an aqueous medium in the presence of a surfactant and resin microparticles. The aqueous medium may be water alone, or a mixture of water with an organic solvent such as an alcohol (such as methanol, isopropanol alcohol, and ethylene glycol), dimethylformamide, tetrahydrofuran, a cellosolve (such as methyl cellosolve), or a lower ketone (such as acetone and methyl ethyl ketone). The amount in which the aqueous medium is used is usually 50 to 2000 weight parts, and preferably 100 to 1000 weight parts, per 100 weight parts toner material liquid. The dispersion state of the toner material liquid will be poor and toner particles of the desired size will not be obtained if the amount is less than 50 weight parts. Economic efficiency will be lost if the weight part is over 2000.

A dispersant such as a surfactant or resin microparticles is added as needed in order to improve dispersion in the aqueous medium.

Examples of surfactants include anionic surfactants such as alkylbenzenesulfonates, α-olefin sulfonates, and phosphates; cationic surfactants such as amine salt types (such as alkylamine salts, aminoalcohol fatty acid derivatives, polyamine fatty acid derivatives, and imidazoline), and quaternary ammonium salt types (such as alkyltrimethyl ammonium salts, dialkyldimethyl ammonium salts, alkyldimethyl benzyl ammonium salts, pyridinium salts, alkyl isoquinolinium salts, and benzethonium chloride); nonionic surfactants such as fatty acid amide derivatives and polyhydric alcohol derivatives; and amphoteric surfactants such as alanine, dodecyldi(aminoethyl)glycine, di(octylaminoethyl)glycine, and N-alkyl-N,N-dimethylammonium betaine.

An effect can be obtained by using just an extremely small amount of a surfactant having a fluoroalkyl group. Examples of anionic surfactants having a fluoroalkyl group that can be used to advantage include C₂ to C₁₀ fluoroalkylcarboxylic acids and metal salts thereof, disodium perfluorooctanesulfonylglutamate, sodium 3-[ω-fluoroalkyl(C₆-C₁₁) oxy]-1-alkyl (C₃-C₄) sulfonate, sodium 3-[ω-fluoroalkanoyl (C₆-C₈)-N-ethylamino]-1-propanesulfonate, fluoroalkyl(C₁₁-C₂₀)carboxylic acids and metal salts thereof, perfluoroalkylcarboxylic acids (c7-c13) and metal salts thereof, perfluoroalkyl(C₄-C₁₂)sulfonates and metal salts thereof, perfluorooctanesulfonic acid diethanol amide, N-propyl-N-(2-hydroxyethyl)perfluorooctanesulfonamide, perfluoroalkyl(C₆-C₁₀) sulfonamide propyltrimethyl ammonium salts, perfluoroalkyl(C₆-C₁₀)—N-ethylsulfonylglycine salts, and monoperfluoroalkyl (C₆-C₁₆) ethylphosphate ester.

Examples of trade names include Surflon S-111, S-112, and S-113 (made by Asahi Glass), Fluorad FC-93, FC-95, FC-98, and FC-129 (made by Sumitomo 3M), Unidyne DS-101 and DS-102 (made by Daikin Industries), Megafac F-110, F-120, F-113, F-191, F-812, and F-833 (made by Dainippon Ink and Chemicals), Ectop EF-102, 103, 104, 105, 112, 123A, 306A, 501, 201, and 204 (made by Tohchem Products), and Futargent F-100 and F150 (made by Neos).

Examples of cationic surfactants include primary, secondary, and tertiary aliphatic amines having a fluoroalkyl group, aliphatic quaternary ammonium salts such as perfluoroalkyl(C₆-C₁₀)sulfonamide propyltrimethyl ammonium salts, benzalkonium salts, benzetonium chloride, pyridinium salts, and imidazolinium salts. Examples of trade names include Surflon S-121 (made by Asahi Glass), Fluorad FC-135 (made by Sumitomo 3M), Unidyne DS-202 (made by Daikin Industries), Megafac F-150 and F-824 (made by Dainippon Ink and Chemicals), Ectop EF-132 (made by Tohchem Products), and Ftergent F-300 (made by Neos).

The resin microparticles can consist of any resin that can form an aqueous dispersion, and may be either a thermoplastic resin or a thermosetting resin. Examples include vinyl resins, polyurethane resins, epoxy resins, polyester resins, polyamide resins, polyimide resins, silicon-based resins, phenolic resins, melamine resins, urea resins, aniline resins, ionomer resins, and polycarbonate resins. Two or more types of the above resins also be used together.

Of these, vinyl resins, polyurethane resins, epoxy resins, polyester resins, and mixtures thereof are preferable in terms of easily obtaining an aqueous dispersion of fine spherical particles. Examples of vinyl resins include homopolymers and copolymers of vinyl monomers, such as styrene-(meth)acrylate ester copolymers, styrene-butadiene copolymers, (meth)acrylic acid-acrylate ester copolymers, styrene-acrylonitrile copolymers, styrene-maleic anhydride copolymers, and styrene-(meth)acrylic acid copolymers. The average size of the resin microparticles is from 5 to 200 nm, and preferably from 20 to 300 nm.

Tricalcium phosphate, calcium carbonate, titanium oxide, colloidal silica, hydroxyapatite, and other such inorganic compound dispersants can also be used.

The dispersion droplets may also be stabilized with a macromolecular protective colloid as a dispersant that can be used together with the above-mentioned resin microparticles and inorganic compound dispersant. Examples include acids (such as acrylic acid, methacrylic acid, α-cyanoacrylic acid, α-cyanomethacrylic acid, itaconic acid, crotonic acid, fumaric acid, maleic acid, and maleic anhydride), (meth)acrylic monomers containing a hydroxyl group (such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid esters, diethylene glycol monomethacrylic acid esters, glycerol monoacrylic acid esters, glycerin monomethacryl ester, N-methylolacrylamide, and N-methylolmethacrylamide), vinyl alcohol and vinyl alcohol ethers (such as vinyl methyl ether, vinyl ethyl ether, and vinyl propyl ether), esters of vinyl alcohol with a compound having a carboxyl group (such as vinyl acetate, vinyl propionate, and vinyl butyrate), acrylamides (such as acrylamide, methacrylamide, and diacetoneacrylamide) and methylol compounds thereof, acid chlorides (such as acrylic acid chloride and methacrylic acid chloride), and nitrogen-containing compounds (such as vinyl pyridine, vinyl pyrrolidone, vinyl imidazole, and ethyleneimine), or homopolymers or copolymers such as those having hetero rings thereof, polyoxyethylene compounds (such as polyoxyethylene, polyoxypropylene, polyoxyethylenealkylamine, polyoxypropylenealkylamine, polyoxyethylenealkylamide, polyoxypropylenealkylamide, polyoxyethylene nonylphenyl ether, polyoxyethylene laurylphenyl ether, polyoxyethylene stearylphenyl ester, and polyoxyethylene nonylphenyl ester), and cellulose compounds such as methyl cellulose, hydroxyethyl cellulose, and hydroxypropyl cellulose.

There are no particular restrictions on the method of dispersion, but low-speed shearing, high-speed shearing, friction methods, high-pressure jetting, ultrasonic methods, and other such known methods can be used. Of these, high-speed shearing is preferable in order to obtain a dispersion with a particle size of 2 to 20 μm. When a high-speed shearing type of dispersion machine is used, there are no particular restrictions on the speed thereof, but the speed is usually from 1000 to 30,000 rpm, and preferably from 5000 to 20,000 rpm. There are no particular restrictions on the dispersion time, but when a batch method is employed, the duration is usually from 0.1 to 5 minutes. The temperature during dispersion is usually from 0 to 150° C. (under pressure), and preferably from 40 to 98° C.

3) Simultaneously with the production of the emulsion, the amine (B) is added and reacted with the polyester prepolymer (A) having an isocyanate group. This reaction brings about crosslinking and/or extension of the molecular chain. The reaction time is selected according to the reactivity between the amine (B) and the isocyanate group structure of the polyester prepolymer (A), but is usually from 10 minutes to 40 hours, and preferably from 2 to 24 hours. The reaction temperature is usually from 0 to 150° C., and preferably from 40 to 98° C. A known catalyst can also be used as needed. Specific examples of this catalyst include dibutyltin laurate and dioctyltin laurate.

4) Upon completion of the reaction, the organic solvent is removed from the emulsified dispersion (reaction product), and washed and dried to obtain toner matrix particles. To remove the organic solvent, the entire system is gradually heated under laminar flow stirring, vigorous agitation is imparted once a specific temperature is reached, and the solvent is then removed to produce spindle-shaped toner matrix particles. When a substance capable of dissolving in an acid or an alkali, such as calcium phosphate, is used as a dispersion stabilizer, the calcium phosphate is removed from the toner matrix particles by a method in which the calcium phosphate is dissolved with an acid such as hydrochloric acid, and then washed with water, for example. This removal can also be accomplished by an operation such as decomposition with an enzyme.

5) The charge control agent is mixed into the toner matrix particles obtained above, and inorganic microparticles such as silica microparticles or titanium oxide microparticles are then added to obtain a toner. The admixing of the charge control agent and the addition of the inorganic microparticles are accomplished by a known method using a mixer or the like. In this way, toner with a small particle size and a sharp particle size distribution can be easily obtained. Furthermore, the shape of the particles can be controlled between spherical and spindle-shaped, and the surface morphology can be controlled between smooth and a prune-like wrinkled texture, by applying vigorous agitation in the course of removing the organic solvent.

The shape of the toner pertaining to this embodiment is substantially spherical, and can be expressed by the following shape restrictions.

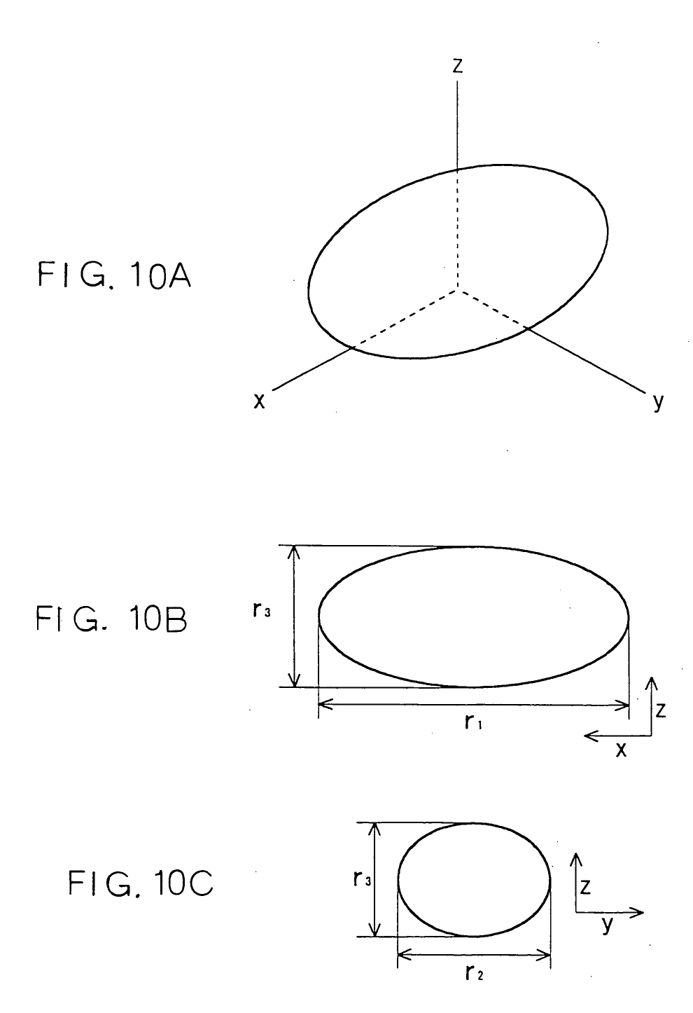

FIGS. 10A to 10C are diagrams illustrating the simplified external shape of the toner of the present invention. In FIGS. 10A to 10C, a substantially spherical toner particle is assumed to have a major axis r1, a minor axis r2, and a thickness r3 (where r1≧r2≧r3), and the toner of this embodiment preferably has a ratio of major axis to minor axis (r2/r1; see FIG. 10B) of from 0.5 to 1.0, and a ratio of thickness to minor axis (r3/r2; see FIG. 10C) of from 0.7 to 1.0. If the ratio of major axis to minor axis (r2/r1) is less than 0.5, the shape will not be that of a true sphere, so dot reproducibility and transfer efficiency will be inferior and a high-quality image will not be obtained. If the ratio of thickness to minor axis (r3/r2) is less than 0.7, the shape of the particle will be closer to flat, and the transfer efficiency will not be as high as with a spherical toner. In particular, if the ratio of thickness to minor axis (r3/r2) is 1.0, the major axis will serve as the rotational axis of the particle, which increases the fluidity of the toner.

r1, r2, and r3 were measured from micrographs taken with a scanning electron microscope (SEM) at various visual field angles.

A toner manufactured as above can be used as a non-magnetic toner, or as a magnetic toner in a one-component system in which no magnetic carrier is used.

When the toner is used in a two-component developer, it may be mixed with a magnetic carrier. The magnetic carrier is preferably a ferrite containing iron, magnetite, manganese, zinc, copper, or another such divalent metal, and has a volume average particle size of 20 to 100 μm. If the average particle size is less than 20 μm, the carrier will tend to stick to the photosensitive body 1 during developing, but if the size is over 100 μm, the carrier will not mix well with the toner, the amount of toner charging will be inadequate, and improper charging will occur during continuous use, among other problems. Copper ferrite containing zinc is preferable because of its high saturated magnetization, but the carrier can be suitably selected as dictated by the process performed by the image forming apparatus 100. There are no particular restrictions on the resin that covers the magnetic carrier, but examples include silicone resins, styrene-acrylic resins, fluororesins, and olefin resins. The manufacturing method here may be to dissolve the coating resin in a solvent and spray this solution into a fluid layer to coat the core, or to cause the resin particles to adhere electrostatically to the nucleus particles, then heat and melt the resin to achieve coverage. The thickness of the covering resin is from 0.05 to 10 μm, and preferably from 0.3 to 4 μm.

The above example provides a charging apparatus, process cartridge, and image forming apparatus with which fluctuations in the charging current can be suppressed, and image defects caused by filming and the like can be prevented, by specifying a permissible gap fluctuation value by quantitatively ascertaining the relationship between the fluctuation in charging current and the fluctuation in the gap between the photosensitive body and the charging roller.

### Second Embodiment

This embodiment is primarily intended to achieve the above-mentioned second object of the present invention.

FIGS. 1, 2, 3, 9A, 9B, and 10A to 10C referred to in the first embodiment above, and the descriptions of these drawings, all substantially apply to this embodiment as well, so these drawings will not be described again.

As discussed above, again in this embodiment, the charging roller 3a is connected to a power supply, and a specific voltage is applied thereto. This voltage consists of alternating current (AC) voltage superimposed over DC voltage. Applying AC voltage allows the surface of the photosensitive drum 1 to be charged more uniformly. As discussed above, however, if too much AC current flows, filming will occur on the photosensitive body surface, so the AC current level needs to be precisely controlled.

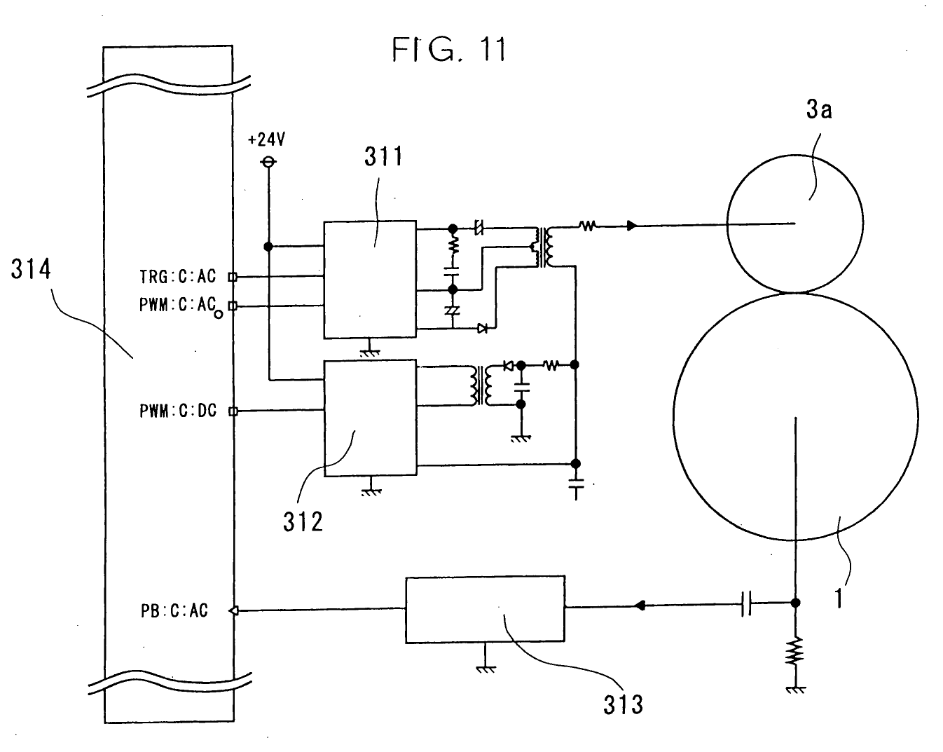

FIG. 11 illustrates the constitution of a power supply circuit and an AC current detection means of the charging apparatus pertaining to this embodiment. The power supply circuit shown here applies high voltage to one of the above-mentioned four photosensitive bodies. Therefore, the tandem image forming apparatus of this embodiment has four of these power supply circuits. Each power supply circuit comprises an AC output circuit 311 and a DC output circuit 312, and is equipped with two voltage boosters so as to obtain a stable charging bias voltage. It is also possible to use just one voltage booster, but two are better when stability of the output is considered.

When charging bias voltage consisting of AC bias voltage superimposed over DC bias voltage is applied to the charging roller, AC current flows through the charging roller and the photosensitive drum into an AC current feedback circuit. An AC current detection means 313 for detecting just AC current is provided on the ground side of the image carrier here, and the AC current thus detected is inputted to a control board 314 and compared to see if it is within a specific range of current values. If it is outside this range, the applied AC bias voltage is controlled so that the current will come within this range. Therefore, even if the charging roller 3a and the charging apparatus 3 are some distance away from the power supply circuit, and current produced by stray capacity due to the routing of the cable between these components or the like flows from the charging roller 3a to the photosensitive drum, it will be possible to adjust the AC charging current produced by the application of the AC bias voltage to within the specified range.

The inventors conducted an experiment in which they applied AC bias voltage so as to vary the AC charging current with a frequency of 1.1 kHz between 650 and 750 μA. As a result, filming did not occur between 650 and 690 μA, but did occur between 720 and 750 μA. Thus grounding the AC current detection means between the control board and the ground side of the photosensitive body quantitatively ensures a range of AC current values in which no filming will occur, so even if there is current flow resulting from stray capacity due to the environment, cable routing, or the like, the current can be kept within the above-mentioned range and filming can be easily prevented. In this embodiment, the AC current detection means 313 is provided on the same substrate as the power supply circuit of the charging apparatus 3 for the sake of ease of maintenance, but the AC current detection means 313 can instead be mounted on the control board 314.

The charging apparatus 3 described above can be a process cartridge that integrally supports the photosensitive body 1 and is formed so as to be removable from the image forming apparatus main body. The process cartridge may also comprise the developing apparatus 5 and/or the cleaning apparatus 7, and the lubricant application apparatus 21. This process cartridge minimizes variance in stray capacity by somewhat fixing the routing of the cable from the photosensitive body to the AC current detection means and from the power supply circuit of the charging apparatus 3 to the charging roller, which makes it possible to narrow the range of applied AC voltage.

The use of a process cartridge is also advantageous in terms of maintenance. Should a malfunction occur in the photosensitive body 1, the charging apparatus 3, a cleaning apparatus 15, the lubricant application apparatus 21, and/or the developing apparatus 5, or the like, the apparatus can be quickly restored to its original condition merely by replacing the cartridge, so servicing takes less time. Also, making the developing photosensitive body 1 easier to clean greatly helps to extend the service life of the process cartridge.

The image forming apparatus of this embodiment is particularly effective when using a toner with a small particle size and spherical particles, as discussed below. The toner used in the developing apparatus 5 preferably has a volume average particle diameter of from 3 to 8 μm, and a ratio (Dv/Dn) of the volume average particle diameter (Dv) to the number average particle diameter (Dn) of from 1.00 to 1.40. Using a toner with a small particle size allows the toner to adhere more securely to the latent image. However, if the volume average particle size is below the range given in this embodiment, when used as a two-component developer, the toner will fuse to the surface of the magnetic carrier during long-term agitation in the developing apparatus, which lowers the charging performance of the magnetic carrier. When used as a one-component developer, the toner will tend to film the developing roller, and fuse to the blade or other member used to spread the toner out in a thin layer. Conversely, if the volume average particle size of the toner is over the range given in this embodiment, it will be difficult to obtain an image of high quality and high resolution, and there will often be large fluctuations in the particle size of the toner when the amount of toner in the developer is adjusted.

Also, narrowing the particle size distribution results in a more uniform distribution of charge over the toner and allows a high-quality image with little substrate fogging to be obtained, and also affords a higher transfer efficiency. However, it is undesirable for Dv/Dn to be over 1.40 because the charge quantity distribution will be wide and resolution will decrease.

The average particle size and particle size distribution of the toner can be measured using a Coulter Counter TA-II or a Coulter Multisizer II (both made by Coulter). In the present invention, these were measured by connecting a Coulter Counter TA-II to a computer (PC9801, made by NEC) and an interface (made by Nikka Giken) for outputting the count distribution and volume distribution.

The toner of the image forming apparatus pertaining to this embodiment can be the toner described in detail in the first embodiment given above. Therefore, this toner will not be described in detail again, but the resin microparticles in this embodiment are added in order to stabilize the toner matrix particles formed in an aqueous medium. Accordingly, it is preferable for them to be added such that the coverage on the surface of the toner matrix particles is between 10 and 90%. Examples include polymethyl methacrylate microparticles having a size of 1 μm and 3 μm, polystyrene microparticles having a size of 0.5 μm and 2 μm, poly(styrene-acrylonitrile) microparticles having a size of 1 μm, PB-200H (made by Kao), SGP (made by Soken), Technopolymer SB (made by Sekisui Plastics), SPG-3G (made by Soken), and Micropearl (made by Sekisui Fine Chemical). Also, inorganic compound dispersing agents such as tricalcium phosphate, calcium carbonate, titanium oxide, colloidal silica, hydroxyapatite can be used.

This embodiment provides an image forming apparatus that is unaffected by stray capacity resulting from the environment, cable routing, and so forth, and with which the AC current of a charging apparatus can be accurately detected and a photosensitive body can be charged more uniformly, the result of which is that no filming occurs on the photosensitive body, and high-quality printing can be achieved.

Various modifications will become possible for those skilled in the art after receiving the teachings of the present disclosure without departing from the scope thereof.

1. A charging apparatus comprising a charging roller provided at a minute gap away from an image carrier, for performing charging,
wherein the relationship Gmax−Gmin≦40 (μm) is satisfied when the gap (μm) between the charged side of the image carrier and the charging side of the charging roller has a maximum value Gmax (μm) and a minimum value Gmin (μm).

2. The charging apparatus as claimed in claim 1, wherein the gap between the charged side of the image carrier and the charging side of the charging roller is maintained by a non-conductive gap member provided at the ends of the charging roller.

3. The charging apparatus as claimed in claim 2, wherein the gap member comprises a film that is wound around the charging roller.

4. The charging apparatus as claimed in claim 2, wherein the gap member comprises a molding that is molded integrally with the charging roller.

5. The charging apparatus as claimed in claim 2, wherein the gap member comprises a heat-shrinkable tube.

6. A process cartridge that can be attached to and removed from the main body of an image forming apparatus, comprising:
an image carrier for carrying a latent image; and
charging means supported integrally with the image carrier, for uniformly charging the surface of the image carrier,
wherein the charging means is disposed at a minute gap away from the image carrier, and the relationship Gmax−Gmin≦40 (μm) is satisfied when the gap (μm) between the charged side of the image carrier and the charging side of the charging roller has a maximum value Gmax (μm) and a minimum value Gmin (μm).

7. An image forming apparatus, comprising:
an image carrier for carrying a latent image;
charging means for uniformly charging the surface of the image carrier;
exposure means for writing a latent image by exposing the surface of the charged image carrier on the basis of image data;
developing means for producing a visible image by supplying toner to the latent image formed on the image carrier surface;
transfer means for transferring the visible image on the image carrier surface to a transfer medium; and
cleaning means for cleaning the image carrier surface after transfer,
wherein the charging means is disposed at a minute gap away from the image carrier, and the relationship Gmax−Gmin≦40 (μm) is satisfied when the gap (μm) between the charged side of the image carrier and the charging side of the charging roller has a maximum value Gmax (μm) and a minimum value Gmin (μm).

8. The image forming apparatus as claimed in claim 7, wherein the toner is one produced by subjecting a toner composition containing at least a polyester prepolymer having a nitrogen atom-containing functional group, a polyester, a colorant, and a parting agent to a crosslinking and/or extension reaction in the presence of resin microparticles in an aqueous solvent.

9. The image forming apparatus as claimed in claim 8, wherein the toner is one whose average circularity is between 0.93 and 1.00.

10. The image forming apparatus as claimed in claim 8, wherein the toner has a ratio of volume average particle diameter to number average particle diameter (dispersibility) of from 1.00 to 1.40.

11. The image forming apparatus as claimed in claim 8, wherein the toner is substantially spherical in its external shape, the ratio of major axis to minor axis (r2/r1) is from 0.5 to 1.0, the ratio of thickness to minor axis (r3/r2) is from 0.7 to 1.0, and the relationship major axis r1≧minor axis r2≧thickness r3 is satisfied.

12. An image forming apparatus, comprising:
a main body;
an image carrier for carrying a latent image;
charging means for uniformly charging the surface of the image carrier;
exposure means for writing a latent image by exposing the surface of the charged image carrier on the basis of image data;
developing means for producing a visible image by supplying toner to the latent image formed on the image carrier surface;
transfer means for transferring the visible image on the image carrier surface to a transfer medium;
cleaning means for cleaning the image carrier surface after transfer; and
a process cartridge that can be attached to and removed from the main body,
the process cartridge including:
the image carrier; and
the charging means supported integrally with the image carrier,
wherein the charging means is disposed at a minute gap away from the image carrier, and the relationship Gmax−Gmin≦40 (μm) is satisfied when the gap (μm) between the charged side of the image carrier and the charging side of the charging roller has a maximum value Gmax (μm) and a minimum value Gmin (μm).

13. The image forming apparatus as claimed in claim 12, wherein the toner is one produced by subjecting a toner composition containing at least a polyester prepolymer having a nitrogen atom-containing functional group, a polyester, a colorant, and a parting agent to a crosslinking and/or extension reaction in the presence of resin microparticles in an aqueous solvent.

14. The image forming apparatus as claimed in claim 13, wherein the toner is one whose average circularity is between 0.93 and 1.00.

15. The image forming apparatus as claimed in claim 13, wherein the toner has a ratio of volume average particle diameter to number average particle diameter (dispersibility) of from 1.00 to 1.40.

16. The image forming apparatus as claimed in claim 13, wherein the toner is substantially spherical in its external shape, the ratio of major axis to minor axis (r2/r1) is from 0.5 to 1.0, the ratio of thickness to minor axis (r3/r2) is from 0.7 to 1.0, and the relationship major axis r1≧minor axis r2≧thickness r3 is satisfied.

17. A toner used in an image forming apparatus, produced by subjecting a toner composition containing at least a polyester prepolymer having a nitrogen atom-containing functional group, a polyester, a colorant, and a parting agent to a crosslinking and/or extension reaction in the presence of resin microparticles in an aqueous solvent,
the image forming apparatus comprising:
an image carrier for carrying a latent image;
charging means for uniformly charging the surface of the image carrier;
exposure means for writing a latent image by exposing the surface of the charged image carrier on the basis of image data;
developing means for producing a visible image by supplying toner to the latent image formed on the image carrier surface;
transfer means for transferring the visible image on the image carrier surface to a transfer medium; and
cleaning means for cleaning the image carrier surface after transfer,
wherein the charging means is disposed at a minute gap away from the image carrier, and the relationship Gmax−Gmin≦40 (μm) is satisfied when the gap (μm) between the charged side of the image carrier and the charging side of the charging roller has a maximum value Gmax (μm) and a minimum value Gmin (μm).

18. The toner as claimed in claim 17, wherein the average circularity of the toner is between 0.93 and 1.00.

19. The toner as claimed in claim 17, wherein the ratio of volume average particle diameter to number average particle diameter (dispersibility) is between 1.00 and 1.40.

20. The toner as claimed in claim 17, wherein the toner is substantially spherical in its external shape, the ratio of major axis to minor axis (r2/r1) is from 0.5 to 1.0, the ratio of thickness to minor axis (r3/r2) is from 0.7 to 1.0, and the relationship major axis r1≧minor axis r2≧thickness r3 is satisfied.

21. A toner used in an image forming apparatus, produced by subjecting a toner composition containing at least a polyester prepolymer having a nitrogen atom-containing functional group, a polyester, a colorant, and a parting agent to a crosslinking and/or extension reaction in the presence of resin microparticles in an aqueous solvent,
the image forming apparatus comprising:
a main body;
an image carrier for carrying a latent image;
charging means for uniformly charging the surface of the image carrier;
exposure means for writing a latent image by exposing the surface of the charged image carrier on the basis of image data;
developing means for producing a visible image by supplying toner to the latent image formed on the image carrier surface;
transfer means for transferring the visible image on the image carrier surface to a transfer medium;
cleaning means for cleaning the image carrier surface after transfer; and
a process cartridge that can be attached to and removed from the main body,
the process cartridge including:
the image carrier; and
the charging means supported integrally with the image carrier,
wherein the charging means is disposed at a minute gap away from the image carrier, and the relationship Gmax−Gmin≦40 (μm) is satisfied when the gap (μm) between the charged side of the image carrier and the charging side of the charging roller has a maximum value Gmax (μm) and a minimum value Gmin (μm).

22. The toner as claimed in claim 21, wherein the toner is one whose average circularity is between 0.93 and 1.00.

23. The toner as claimed in claim 21, wherein the toner has a ratio of volume average particle diameter to number average particle diameter (dispersibility) of from 1.00 to 1.40.

24. The toner as claimed in claim 21, wherein the toner is substantially spherical in its external shape, the ratio of major axis to minor axis (r2/r1) is from 0.5 to 1.0, the ratio of thickness to minor axis (r3/r2) is from 0.7 to 1.0, and the relationship major axis r1≧minor axis r2≧thickness r3 is satisfied.

25. An image forming apparatus, comprising:
an image carrier for carrying a latent image;
charging means for uniformly charging the image carrier surface by superimposing an AC bias voltage over a DC bias voltage as the charging bias voltage;
AC current detection means for detecting alternating current flowing through the image carrier during application of the charging bias voltage;
exposure means for writing a latent image by exposing the surface of the charged image carrier on the basis of image data;
developing means for producing a visible image by supplying toner to the latent image formed on the image carrier surface;
transfer means for transferring the visible image on the image carrier surface to a transfer medium;
cleaning means for cleaning the image carrier surface after transfer; and
lubricant application means for applying a lubricant to the image carrier surface,
wherein the current detection means detects alternating current on the ground side of the image carrier.

26. The image forming apparatus as claimed in claim 25, wherein the lubricant application means comprises a brush-like roller, and this brush-like roller rubs against a lubricant molding, scrapes off lubricant, and applies this lubricant to a photosensitive body.

27. The image forming apparatus as claimed in claim 25, wherein the lubricant is a fatty acid metal salt or fluorine particles.

28. The image forming apparatus as claimed in claim 25, wherein the toner used in the developing means has a volume average particle diameter of 3 to 8 μm, and the ratio (Dv/Dn) of the volume average particle diameter (Dv) to the number average particle diameter (Dn) is between 1.00 and 1.40.

29. The image forming apparatus as claimed in claim 25, wherein the toner used in the developing means has a shape factor SF-1 of from 100 to 180, and a shape factor SF-2 of from 100 to 180.

30. The image forming apparatus as claimed in claim 25, wherein the toner used in the developing means is obtained by dispersing at least a polyester prepolymer having a nitrogen atom-containing functional group, a polyester, a colorant, and a parting agent in an organic solvent, and subjecting the resulting toner material solution to a crosslinking and/or extension reaction.

31. The image forming apparatus as claimed in claim 25, wherein the toner used in the developing means is substantially spherical in its external shape, the shape is specified by major axis r1, minor axis r2, and thickness r3 (where r1≧r2≧r3), the ratio of major axis r1 to minor axis r2 (r2/r1) is from 0.5 to 1.0, the ratio of thickness r3 to minor axis r2 (r3/r2) is from 0.7 to 1.0.

32. A toner used in the developing step in an image forming apparatus of an electrophotographic process, wherein the volume average particle diameter is from 3 to 8 μm, and the ratio (Dv/Dn) of the volume average particle diameter (Dv) to the number average particle diameter (Dn) is between 1.00 and 1.40,
the image forming apparatus comprising:
an image carrier for carrying a latent image;
charging means for uniformly charging the image carrier surface by superimposing an AC bias voltage over a DC bias voltage as the charging bias voltage;
AC current detection means for detecting alternating current flowing through the image carrier during application of the charging bias voltage;
exposure means for writing a latent image by exposing the surface of the charged image carrier on the basis of image data;
developing means for producing a visible image by supplying toner to the latent image formed on the image carrier surface;
transfer means for transferring the visible image on the image carrier surface to a transfer medium;
cleaning means for cleaning the image carrier surface after transfer; and
lubricant application means for applying a lubricant to the image carrier surface,
wherein the current detection means detects alternating current on the ground side of the image carrier.

33. The toner as claimed in claim 32, wherein the toner has a shape factor SF-1 of from 100 to 180, and a shape factor SF-2 of from 100 to 180.

34. The toner as claimed in claim 32, wherein the toner is obtained by dispersing at least a polyester prepolymer having a nitrogen atom-containing functional group, a polyester, a colorant, and a parting agent in an organic solvent, and subjecting the resulting toner material solution to a crosslinking and/or extension reaction.

35. The toner as claimed in claim 32, wherein the toner is substantially spherical in its external shape, the shape is specified by major axis r1, minor axis r2, and thickness r3 (where r1≧r2≧r3), the ratio of major axis r1 to minor axis r2 (r2/r1) is from 0.5 to 1.0, the ratio of thickness r3 to minor axis r2 (r3/r2) is from 0.7 to 1.0.
